(19) United States
(12) Patent Application Publication
(10) Pub. No.: US 2012/0120285 A1
(43) Pub. Date: May 17, 2012

(54) METHOD AND APPARATUS FOR RECONFIGURING TIME OF FLIGHT SHOT MODE

(75) Inventor: Dong-Ik Ko, McKinney, TX (US)

(73) Assignee: TEXAS INSTRUMENTS INCORPORATED, Dallas, TX (US)

(21) Appl. No.: 13/292,322

(22) Filed: Nov. 9, 2011

Related U.S. Application Data
(60) Provisional application No. 61/414,332, filed on Nov. 16, 2010.

(51) Int. Cl. H04N 5/217

(52) U.S. Cl. 348/241; 348/E05.078

(57) ABSTRACT

A method and apparatus for configuring Time Of Flight sensor and data transfer for dynamically reconfigurable sensor mode change depending on scene characteristics. The method includes configuring the sensor configuration set on normal shot mode, performing scene analysis on at least one captured scenes, when dynamic motion is detected and the automatic shot mode sensor change is enabled, configuring the sensor to fast shot mode, and when in normal shot mode, capturing and transferring the full size TOF raw pixels for each phase, and when in fast shot mode, capturing and transferring less than all the size of the Time Of Flight raw pixels for each phase.

### CROSS-REFERENCE TO RELATED APPLICATIONS

This application claims benefit of U.S. provisional patent application Ser. No. 61/414,332, filed Nov. 16, 2010, which is herein incorporated by reference.

### BACKGROUND OF THE INVENTION

1. Field of the Invention

Embodiments of the present invention generally relate to a method and apparatus for reconfiguring Time Of Flight sensor capture mode.

2. Description of the Related Art

In Time Of Flight based sensor system, four (4) Time of Flight sensor frames captured are required to build a single depth map frame. As a result, a moving artifact occurs when scenes are quickly changed over these four (4) TOF scene captures. As the image resolution increases, this problem gets more apparent.

Therefore, there is a need for a method and/or apparatus for improving the reconfiguration of Time Of Flight sensor capture mode.

### SUMMARY OF THE INVENTION

Embodiments of the present invention relate to a method and apparatus for configuring Time Of Flight sensor and data transfer for dynamically reconfigurable sensor mode change depending on scene characteristics. The method includes configuring the sensor configuration set on normal shot mode, performing scene analysis on at least one captured scenes, when dynamic motion is detected and the automatic shot mode sensor change is enabled, configuring the sensor to fast shot mode, and when in normal shot mode, capturing and transferring the full size TOF raw pixels for each phase, and when in fast shot mode, capturing and transferring less that all the size of the Time Of Flight raw pixels for each phase.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an embodiment of a moving artifact between normal shot mode and fast shot mode;

FIG. 2 is an embodiment of building a depth map in normal shot mode;

FIG. 3 is an embodiment of Time Of Flight sensor configuration and Time Of Flight data transfer timing in normal shot mode;

FIG. 4 is an embodiment of Time Of Flight depth map from Time Of Flight sensor data in fast shot mode;

FIG. 5 is an embodiment of a Time Of Flight sensor configuration and data transfer in fast shot mode; and

FIG. 6 is a flow diagram depicting an embodiment of a method for configuring Time Of Flight sensor and data transfer for dynamic mode change between normal shot mode and fast shot mode.

### DETAILED DESCRIPTION

To resolve the above defined problem, in one embodiment, Time Of Flight (TOF) sensor capture mode is reconfigured based on scene characteristics. In a static normal scene, i.e. normal shot mode, a full frame is captured in each pixel of TOF sensor and is transferred to a target system camera interface. The TOF sensor is reset for the next scene capture. This repeats several times, such as, four (4) times, in order to obtain a single depth map.

Such an embodiment allows for a reconfigurable TOF sensor capture mode depending on scene characteristics and for reducing a moving artifact in TOF sensor based depth map without costly on-chip buffers.

In a dynamic and fast scene, such as, fast shot mode, each pixel of four neighboring pixels of TOF sensor captures one of four consecutive scenes, respectively. The TOF sensor data is transferred to a target system to build a depth map. In this mode, an image resolution may be four times smaller than normal shot mode, but prevents blurring effect over four (4) consecutive TOF scene captures.

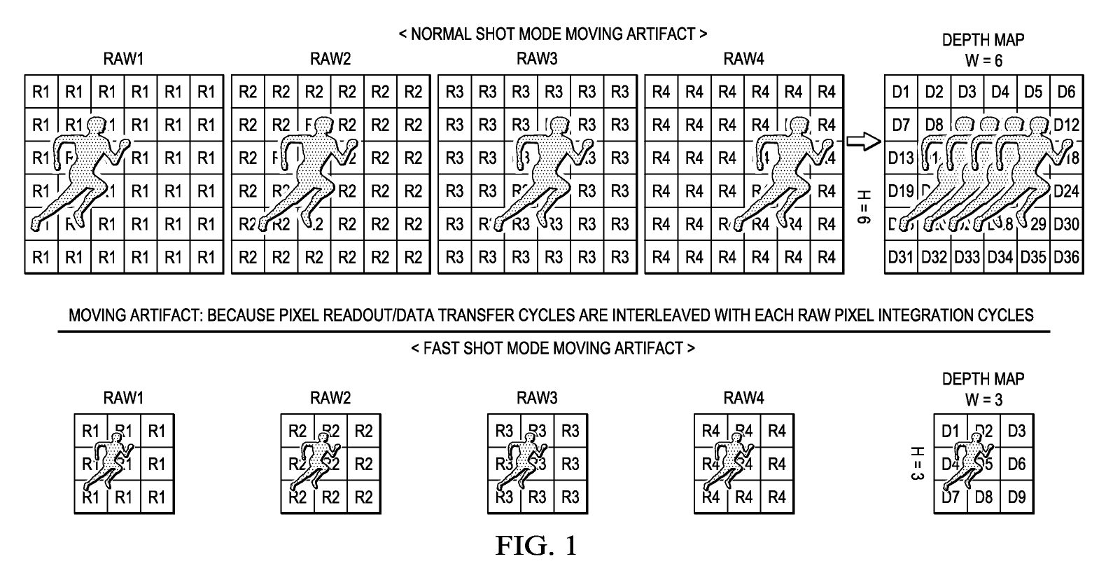

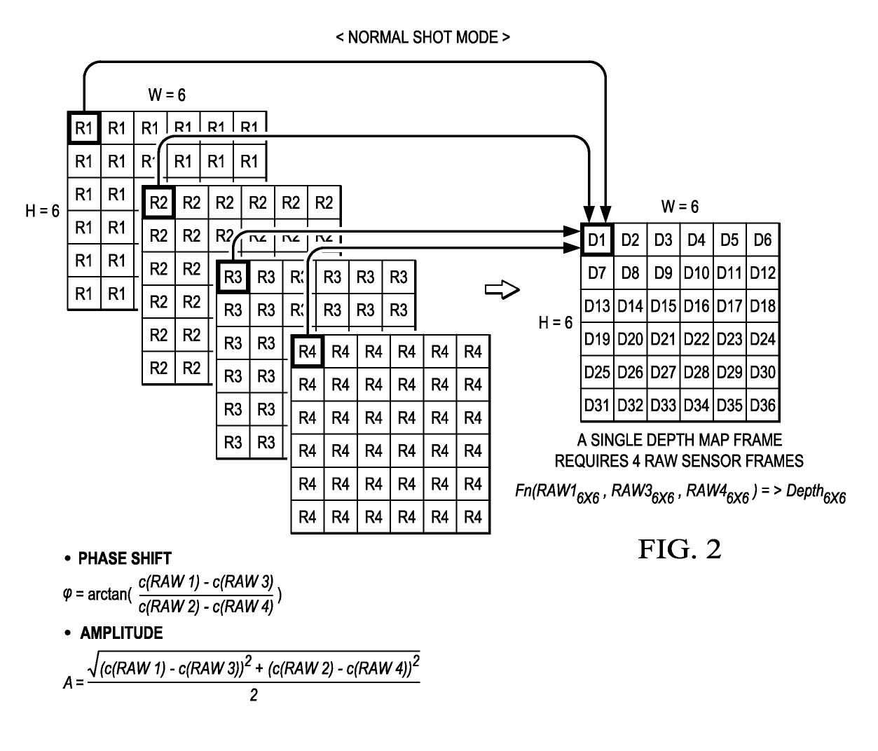

FIG. 1 is an embodiment of a moving artifact between normal shot mode and fast shot mode. Whereas, FIG. 2 is an embodiment of building a depth map in normal shot mode. In FIG. 2, TOF raw sensor's full frames are used to build the depth map in normal shot mode.

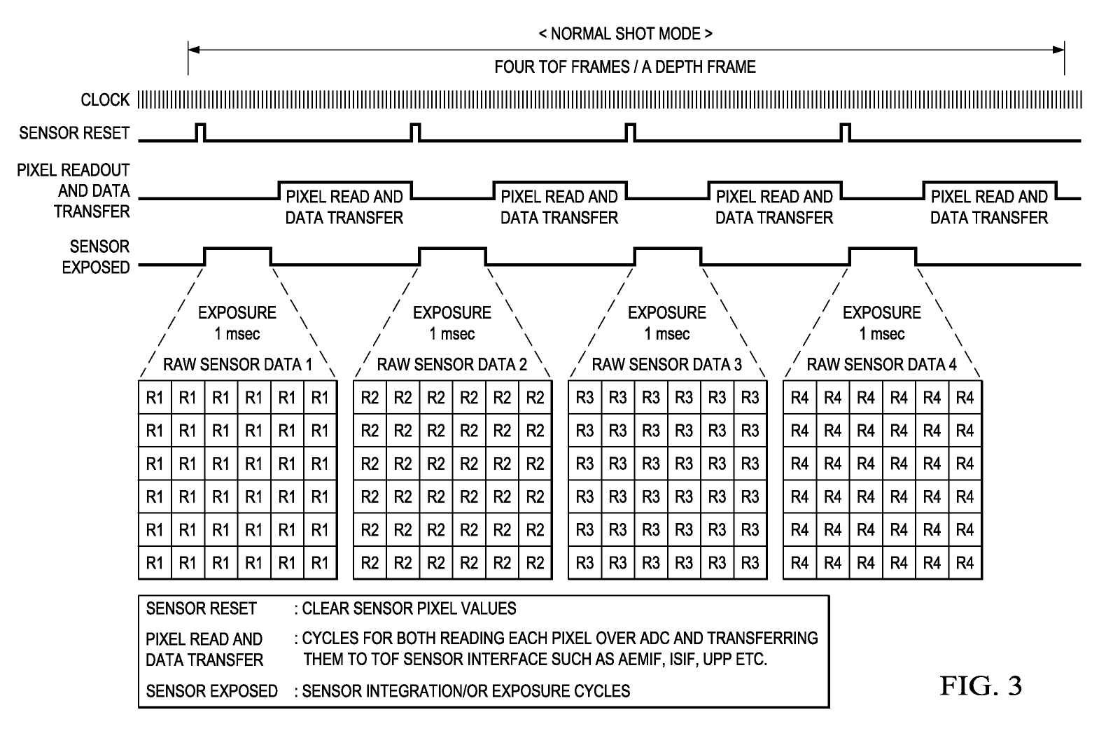

FIG. 3 is an embodiment of a Time Of Flight sensor configuration and data transfer in normal shot mode. FIG. 3 shows TOF data transfer timing and sensor configuration in normal mode shot. From FIG. 2 and FIG. 3, TOF sensor reset, integration and transfer are repeated multiple times, i.e. four (4) times, for the depth map.

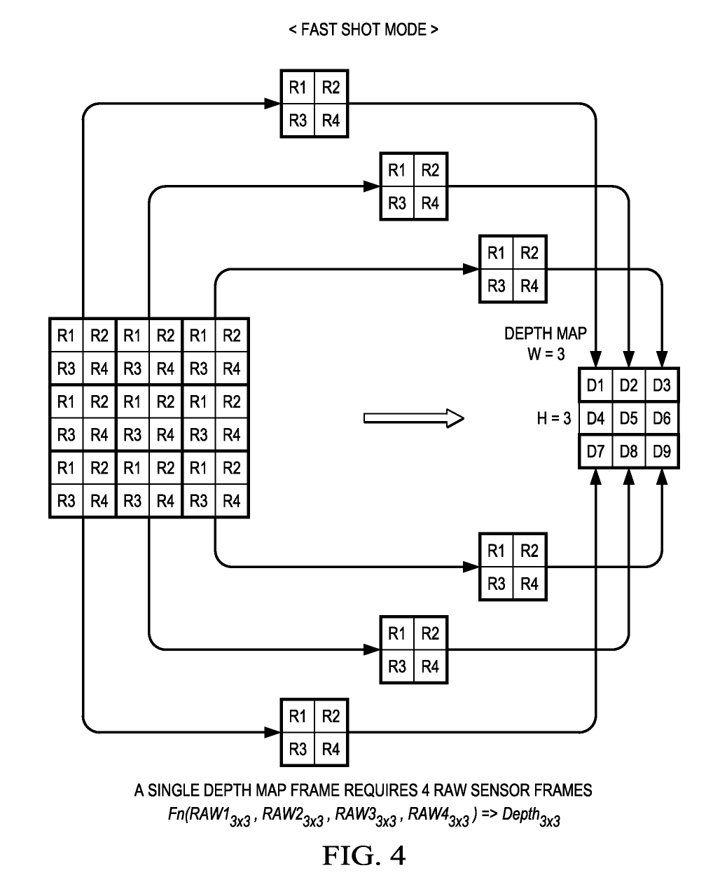

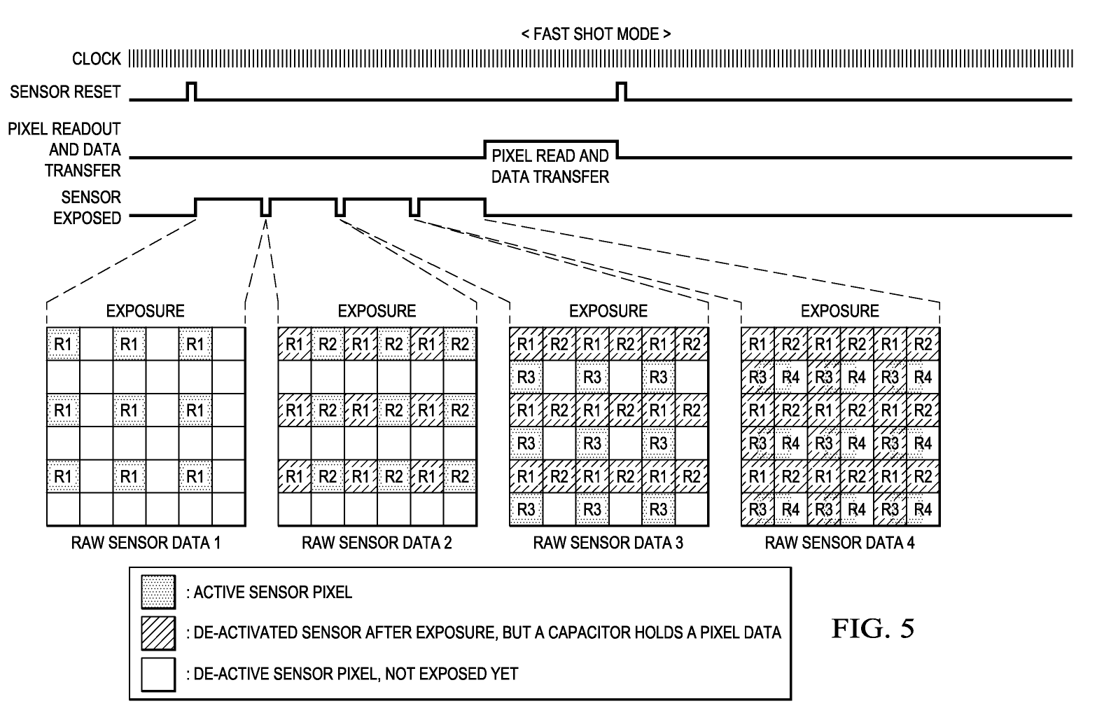

FIG. 4 is an embodiment of a Time Of Flight depth map from Time Of Flight sensor data in fast shot mode. FIG. 5 is an embodiment of a Time Of Flight sensor configuration and data transfer in fast shot mode. Compared to FIG. 2 and FIG. 3, FIG. 4 and FIG. 5 show how TOF sensor configuration and data transfer timing are different in fast shot mode. Existing solution may use multiple frame buffers with high speed ADCs. As a result, the overall system cost increases. By comparing normal shot mode of FIG. 2 and FIG. 3 and fast shot mode of FIG. 4 and FIG. 5, normal shot mode allows for a higher resolution than fast shot mode. Thus, normal shot mode delivers more fine grained depth map for scenes where static information of depth map is more important, such as, surveillance vision, security vision, 3D modeling of objects and the like. In one embodiment, with sacrifice of a sensor resolution, fast mode shot can reduce moving artifact for scenes where objects are dynamically changed over frames, such as, automotive vision and the like. The suggested technique intelligently changes the sensor configuration based on on-the-fly analysis of characteristics of scenes. As a result, TOF sensor can be intelligently adjusted for the key points targeted by each application or each scene in the acquisition of depth map

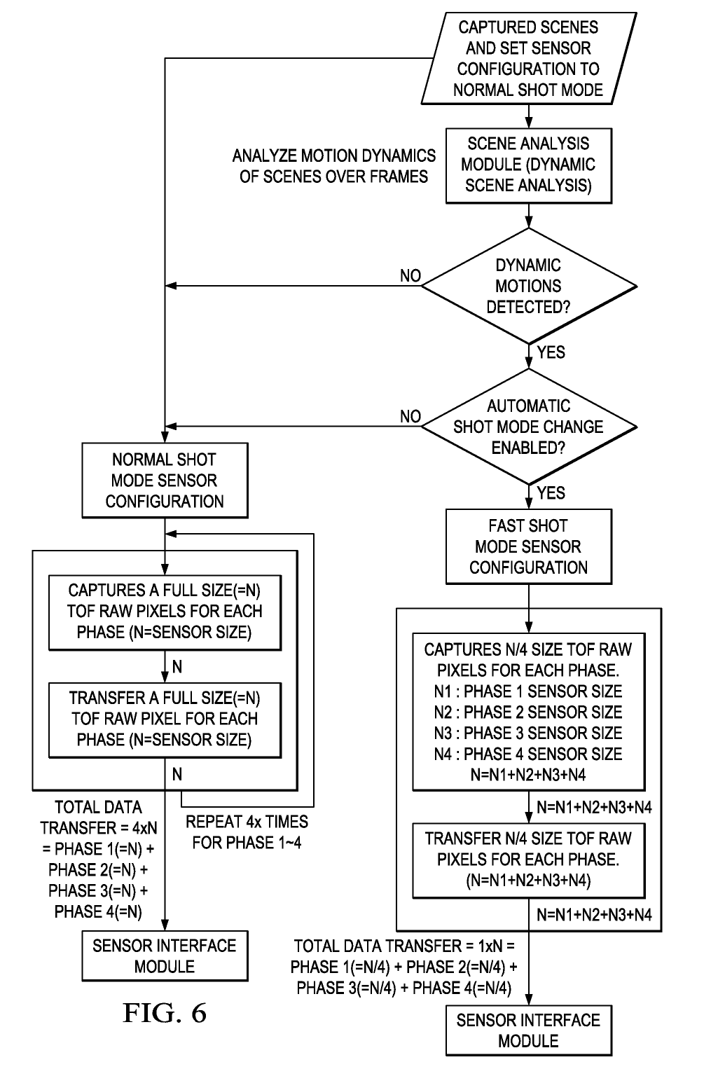

FIG. 6 is a flow diagram depicting an embodiment of a method for configuring Time Of Flight sensor and data transfer for dynamically reconfigurable sensor mode change depending on scene characteristics. The method starts with the sensor configuration set on normal shot mode. Then, scene analysis, i.e. dynamic scene analysis, is performed on captured scenes. If dynamic motion is detected and the automatic shot mode change is enabled, then the sensor is configured to fast shot mode. Otherwise, the sensor is configured to normal shot mode. When in normal shot mode, the full size TOF raw pixels for each phase is captured and transferred. This capturing and transfer may occur multiple times, i.e. four (4) times. When in fast shot mode, N/4 size TOF raw pixels for each phase are captured and transferred where Nₙ is the sensor size used for capturing nₜₕ phase. Thus, in fast shot mode, data transfer for four (4) phases would be N1+N2+N3+N4.

While the foregoing is directed to embodiments of the present invention, other and further embodiments of the invention may be devised without departing from the basic scope thereof, and the scope thereof is determined by the claims that follow.

What is claimed is:

1. A method of a digital processor for configuring Time Of Flight sensor and data transfer for dynamically reconfigurable sensor mode change depending on scene characteristics, comprising:
configuring in the digital processor the sensor configuration set on normal shot mode;
performing scene analysis on at least one captured scenes;
when dynamic motion is detected and the automatic shot mode sensor change is enabled, configuring the sensor to fast shot mode; and
when in normal shot mode, capturing and transferring the full size TOF raw pixels for each phase, and when in the fast shot mode, capturing and transferring less than all the size of the Time Of Flight raw pixels for each phase.

2. The method of claim 1, wherein the scene analysis is a dynamic scene analysis.

3. The method of claim 1, wherein when dynamic motion is not detected and the automatic shot mode sensor change is not enabled, configuring the sensor to normal shot mode.

4. The method of claim 1, wherein the capturing and transfer occurs multiple times.

5. The method of claim 4, wherein the multiple of times is equal to the number of phases.

6. The method of claim 5, wherein the number of phases is four.

7. The method of claims 1, wherein, in the fast shot mode, data transfer for n phases is N1+N2 . . . Nₙ and the capturing and transferring step captures and transfers N/n size Time Of Flight raw pixels for each phase, wherein Nₙ is the sensor size used for capturing nₜₕ phase.

8. The method of claims 1, wherein, in the fast shot mode, data transfer for four phases would be N1+N2+N3+N4 and the capturing and transferring step captures and transfers N/4 size Time Of Flight raw pixels for each phase, wherein Nₙ is the sensor size used for capturing nₜₕ phase.

9. An apparatus for configuring Time Of Flight sensor and data transfer for dynamically reconfigurable sensor mode change depending on scene characteristics, comprising:
means for configuring the sensor configuration set on normal shot mode;
means for performing scene analysis on at least one captured scenes;
when dynamic motion is detected and the automatic shot mode sensor change is enabled, means for configuring the sensor to fast shot mode; and
when in normal shot mode, means for capturing and means for transferring the full size TOF raw pixels for each phase, and when in fast shot mode, means for capturing and means for transferring less than all the size of the Time Of Flight raw pixels for each phase.

10. The method of claim 9, wherein the scene analysis is a dynamic scene analysis.

11. The method of claim 9, wherein when dynamic motion is not detected and the automatic shot mode sensor change is not enabled, configuring the sensor to normal shot mode.

12. The method of claim 9, wherein the capturing and transfer occurs multiple times.

13. The method of claim 12, wherein the multiple of times is equal to the number of phases.

14. The method of claim 13, wherein the number of phases is four.

15. The method of claims 9, wherein, in fast shot mode, data transfer for n phases is N1+N2 . . . Nₙ and the means for capturing and means for transferring captures and transfers N/n size Time Of Flight raw pixels for each phase, wherein Nₙ is the sensor size used for capturing nₜₕ phase.

16. The method of claims 9, wherein, in fast shot mode, data transfer for four phases would be N1+N2+N3+N4 and means for capturing and means for transferring captures and transfers N/4 size Time Of Flight raw pixels for each phase, wherein Nₙ is the sensor size used for capturing nₜₕ phase.

17. A non-transitory storage medium with computer readable executable instruction, when execute, perform a method for configuring Time Of Flight sensor and data transfer for dynamically reconfigurable sensor mode change depending on scene characteristics, the method comprising:
configuring the sensor configuration set on normal shot mode;
performing scene analysis on at least one captured scenes;
when dynamic motion is detected and the automatic shot mode sensor change is enabled, configuring the sensor to fast shot mode; and
when in normal shot mode, capturing and transferring the full size TOF raw pixels for each phase, and when in fast shot mode, capturing and transferring less than all the size of the Time Of Flight raw pixels for each phase.

18. The non-transitory storage medium of claim 17, wherein the scene analysis is a dynamic scene analysis.

19. The non-transitory storage medium of claim 17, wherein when dynamic motion is not detected and the automatic shot mode sensor change is not enabled, configuring the sensor to normal shot mode.

20. The non-transitory storage medium of claim 17, wherein the capturing and transfer occurs multiple times.

21. The non-transitory storage medium of claim 20, wherein the multiple of times is equal to the number of phases.

22. The non-transitory storage medium of claim 21, wherein the number of phases is four.

23. The non-transitory storage medium of claims 17, wherein, in fast shot mode, data transfer for n phases is N1+N2 . . . Nₙ and the capturing and transferring step captures and transfers N/n size Time Of Flight raw pixels for each phase, wherein Nₙ is the sensor size used for capturing nₜₕ phase.

24. The non-transitory storage medium of claims 17, wherein, in fast shot mode, data transfer for four phases would be N1+N2+N3+N4 and the capturing and transferring step captures and transfers N/4 size Time Of Flight raw pixels for each phase, wherein Nₙ is the sensor size used for capturing nₜₕ phase.
